(19) United States
(12) Patent Application Publication
(10) Pub. No.: US 2005/0077668 A1
(43) Pub. Date: Apr. 14, 2005

(54) Modular attachments for surface mount tools

(76) Inventor: Michael F. Clouse, Franklin, TN (US)

Correspondence Address: Richard C. Litman;LITMAN LAW OFFICES, LTD., P.O. Box 15035, Arlington, VA, 22215, US

(21) Appl. No.: 10/942,864

(22) Filed: Sep. 17, 2004

Related U.S. Application Data
(60) Provisional application No. 60/510,115, filed on Oct. 10, 2003.

(51) Int. Cl. B23Q 3/02

(52) U.S. Cl. 269/97

(57) ABSTRACT

The present modular attachments for surface mount tools provide apparatus for removably attaching a normally permanently mounted tool to a support surface. The attachments include a first or support structure mounted base plate and a second, tool mounted plate which engages the first plate. A tool (e.g., vise, grinder, small bench mounted drill press, etc.) is affixed to the second plate. One plate has a series of outwardly extending fingers or flanges, while the other plate has a series of slots in an inwardly extending flange. The outward fingers of one plate insert into the slots of the other plate, with the two plates being locked together when one is turned relative to the other. The modular attachments may be used for securing various types of surface mounted tools and appliances temporarily and interchangeably in place to a workbench or other work surface.

### CROSS REFERENCE TO RELATED PATENT APPLICATION

This application claims the benefit of U.S. Provisional Patent Application Ser. No. 60/510,115, filed on Oct. 10, 2003.

### BACKGROUND OF THE INVENTION

1. Field of the Invention

The present invention relates generally to devices for temporary and removable attachment of normally permanently mounted articles to a base. More specifically, the present invention relates to a modular attachment for mounting a tool normally that is normally a workbench-mounted tool, e.g., a vise, a bench grinder, etc., to any conveniently available work surface.

2. Description of the Related Art

Fixed tools, i.e., tools secured to a support structure of some sort, such as a workbench or other support surface, are commonly used in numerous fields. Vises, drill presses, grinders, routers, table saws, etc., are generally mounted or attached atop or to the underside of a work surface, and remain in place, even when not in use. The installation of several such tools in a reasonably well-equipped workshop necessitates either a relatively large work surface or workbench, or a series of such benches for the different tools. Either way, a substantial amount of room is required for such a large workbench or large number of workbenches, and this may preclude the installation of a series of such tools in smaller home or hobby-type workshops, garages, and the like.

Much the same principle applies to other areas, as well. For example, many kitchens incorporate a number of different countertop power appliances, e.g., blenders, mixers, coffee grinders, etc., which all require countertop space for their operation. The typical kitchen area does not have nearly enough countertop space to permit all of the appliances normally found therein to be deployed for use simultaneously. In addition, many such appliances are preferably used near a source of heat, water, or other resource for convenience, and they cannot all be placed at the same location simultaneously.

Another area where space is at a premium is in motor vehicles of various types, e.g., pickup truck tailgates, cargo areas of vans, etc. Often, a worker or craftsman must travel to a location for the performance of some task, with his or her tools traveling along. There is generally limited space for setting up such tools, and they must be positioned and secured singly as their use is required.

Solutions to these problems have generally included portable, collapsible workbenches with pre-formed holes in the work surfaces for temporary mounting of power tools or appliances, tables with replaceable tabletops having pre-formed holes for mounting power tools or appliances, and tools or appliances with inserts which install within a receptacle within a tabletop or the like.

An example of such is shown in German Patent No. 3,313,268 published on Nov. 15, 1984, which describes (according to the drawings and English abstract) a workbench having a folding leaf. The center of the tabletop has a slot for a table saw or the like. The '268 German patent appears to teach that numerous tables and extensions may be assembled together to form various configurations for various tools.

Another example is illustrated in German Patent No. 3,431,110 published on Mar. 6, 1986, which describes (according to the drawings and English abstract) a workbench with a power tool panel. A power tool may be interchangeably clamped below the table surface by means of a planar insert which clamps within a cutout through the table, from below the table surface.

However, no entirely satisfactory solution to the above-noted problems has been found. Thus, the modular attachments for surface mount tools solving the aforementioned problems are desired.

### SUMMARY OF THE INVENTION

The modular attachments for surface mount tools provides a modular attachment assembly for work surface mounted tools of various types, e.g., vises, small drill presses, grinders, etc. The attachment assembly has a first or bench/work surface plate, which is permanently attached to the workbench or work surface, and a mating, complementary second plate to which the tool is permanently attached. The two plates engage one another with an interlocking, rotary action, with the tool plate and its attached tool being rotated through a partial turn to lock in place on the underlying work surface plate. This arrangement permits the tool to be oriented as desired in any of a number of radial orientations relative to the underlying plate and work surface.

These and other features of the present invention will be readily apparent upon consideration of the following specification and drawings.

### BRIEF DESCRIPTION OF THE DRAWINGS

FIG. 1 is an environmental, perspective view showing the installation and removal of a tool using a modular attachment for surface mount tools according to the present invention.

FIG. 2 is an exploded, detailed perspective view in partial section showing details of the tool attachment components of FIG. 1 and their assembly with one another.

FIG. 3 is an exploded, detailed perspective view in partial section of an alternative embodiment of a modular attachment for surface mount tools similar to FIG. 2, but with the outwardly and inwardly extending flanges reversed in the upper and lower components.

FIGS. 4A and 4B are opposed plan views of another alternate embodiment of the present invention, in which the two components have only three interlocking flanges.

FIGS. 5A and 5B are opposed plan views of yet another alternate embodiment of the present invention, in which the two components have five interlocking flanges.

Similar reference characters denote corresponding features consistently throughout the attached drawings.

### DETAILED DESCRIPTION OF THE PREFERRED EMBODIMENTS

The present invention encompasses various embodiments of modular attachments for temporarily and removably interchanging various surface mounted tools or other similar devices to a work or support surface. Rather than bolting or otherwise affixing the tool(s) permanently to an underlying surface, the present invention allows a user of the tool(s) to install a particular tool (e.g., vise, bench grinder, small drill press stand, etc.) temporarily and interchangeably to a work surface, thereby allowing a smaller work surface or workbench to be used and permitting the storage of tools when not in use. While the present invention is directed to use in the home workshop or similar environment, it may also be used with kitchen appliances or for temporary mounting of tools on a vehicle in the field, etc.

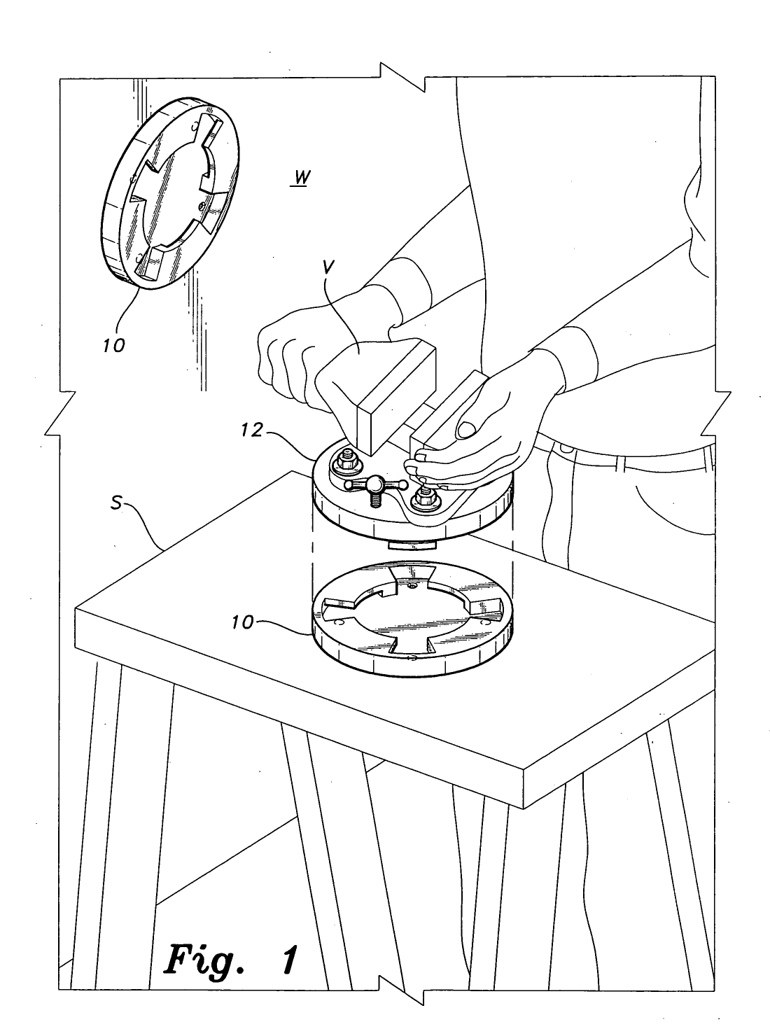

FIG. 1 of the drawings provides an environmental perspective view of a work surface mounted tool, e.g., a bench vise V, in the process of being interchangeably secured to a workbench or work surface S by an embodiment of a modular attachment of the present invention. The modular attachments have a first plate 10 and a mating second plate 12, the two plates 10 and 12 containing a series of mutually-engaging, radially disposed fingers and flanges which interlock together to secure the two plates to one another.

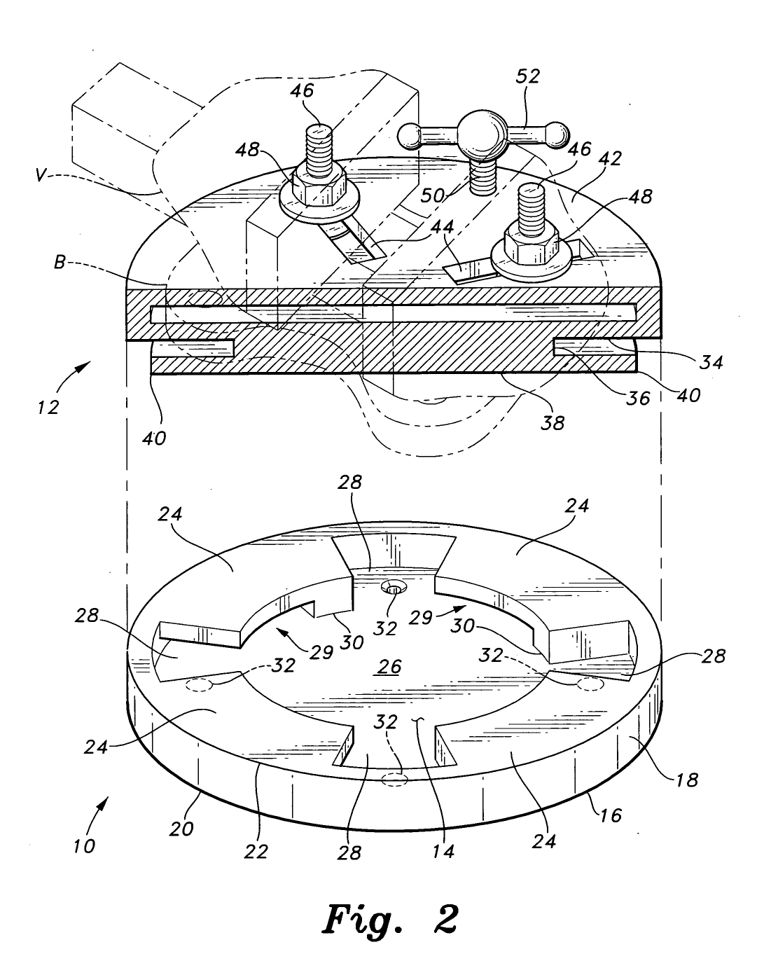

FIG. 2 provides a detailed, exploded perspective view in partial section of the two plates 10 and 12 of FIG. 1. The first or work surface mounting plate 10 (also referred to as a female plate) includes a base 14 having a periphery 16, with a peripheral wall 18 defining a shallow cylinder extending from its base attachment edge 20 with the base periphery 16 to an opposite flange edge 22. A flange 24 extends inwardly from the flange edge 22 of the shallow cylindrical wall 18, with the base 14, wall 18, and flange 22 defining a circular recess or first plate interior 26. The flange 24 includes a plurality of radially disposed finger insertion slots 28 therein, extending outwardly from the interior 26 toward the flange edge 22 of the peripheral wall 18.

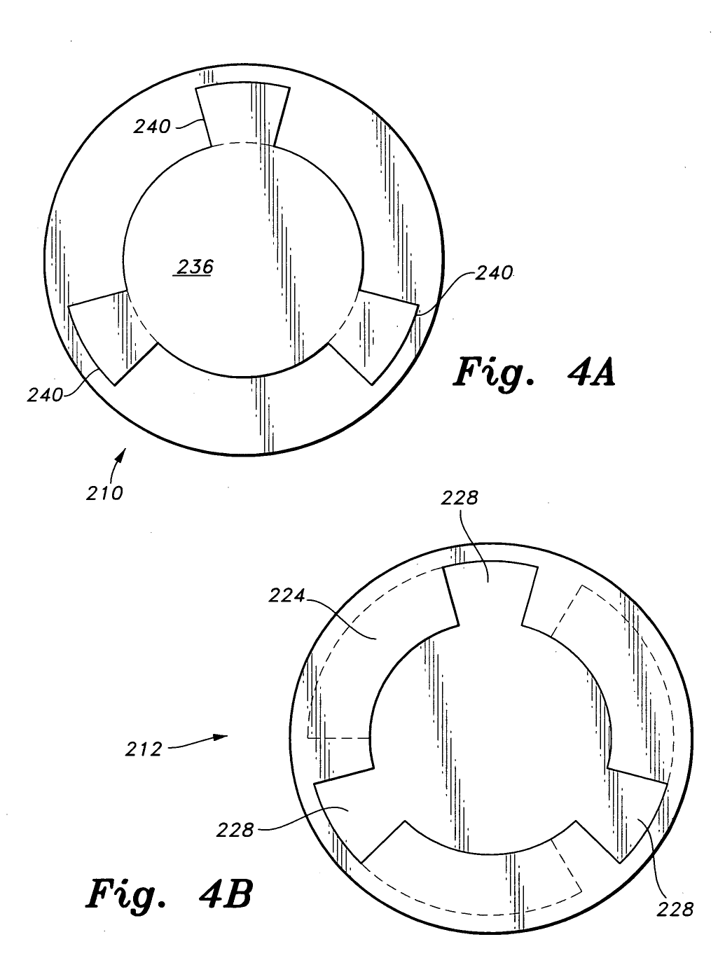

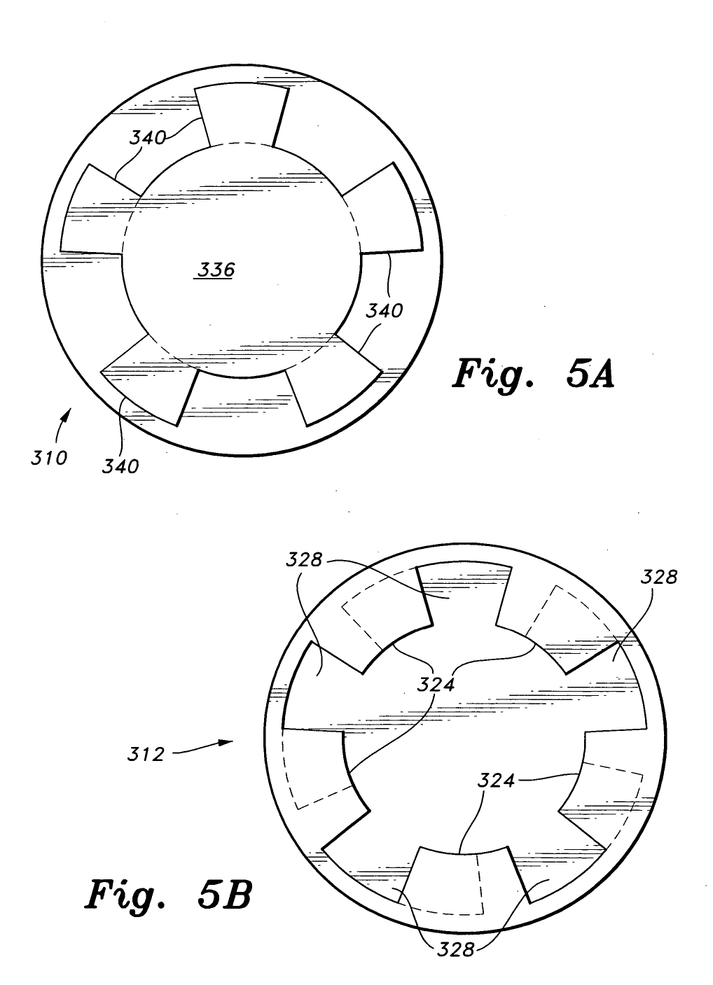

While a series of four finger insertion slots 28 are shown for the first plate embodiment 10 of FIGS. 1 and 2, it will be understood that more or fewer slots may be provided as desired, with examples of such being shown in FIGS. 4A through 5B and discussed further below. Also, while the slots 28 of the embodiment 10 of FIGS. 1 and 2 are shown having equal angular spacing, it will be understood that the slots may be unevenly spaced, if so desired. Equal slot spacing permits the tool attached to the mating tool mount plate 12 to be secured to the underlying surface mount plate 10 in any of a number of different orientations, however.

Each of the segments of one or more of the inwardly disposed flanges 24 may include a rotational stop 30 extending between the flange 24 and the opposite base 14, so that an arcuate locking slot 29 is defined vertically between flange 24 and base 14, and horizontally between finger insertion slot 28 and stop 30. The finger insertion slot 28 and the locking slot 29 are continuous, forming a stubby, L-shaped slot. The stop(s) 30 preclude rotation of the mating fingers of the second plate 12 beyond the stop(s). It will be seen that the stop(s) 30 could be located to the right or left hand end(s) of the flange 24 segments, as desired, depending upon whether clockwise or counterclockwise rotation of the second plate 12 relative to the first plate 10 is desired to lock the two plates together.

The base 14 may include a series of work surface attachment passages 32 therethrough, for the attachment of the first plate 10 to an underlying workbench or work surface S or the like. In FIG. 1, one of the work surface attachment plates 10 is shown secured to a workbench or other work surface S, while another plate 10 is shown attached to a wall W for storage of a suitably equipped tool thereon. The attachment passages 32 are preferably countersunk or recessed in some manner in order to allow the fastener heads to lie flush with or below the inner surface of the base 14 to preclude interference with the second plate 12 when installed thereto. Other first plate attachment means may be used alternatively as appropriate, e.g., clamps, welding to a suitable support structure, etc., as desired.

A mating, complementary second or male plate 12 has a surface mounted tool attached thereto and engages and locks with the first plate 10, thereby removably and interchangeably securing the tool (e.g., the vise V shown in FIG. 1) to the work surface S. The second plate 12 includes a mounting surface 34, which extends across the width or diameter of the second plate 12. A smaller diameter central core 36 extends axially from the mounting surface 34, with the core 36 having a first plate engagement end 38 spaced from the mounting surface 34 a distance equal or slightly greater than the thickness of the flange 24 of the first plate 10. A series of fingers 40 extend radially outwardly from the first plate engagement end 38 of the second plate core 36, with the fingers 40 corresponding in number and passing through the slots 28 of the first plate 10. Thus, when the fingers 40 of the second plate 12 are inserted through the slots 28 of the first plate 10 and the second plate 12 is turned or rotated relative to the first plate 10, the second plate fingers 40 are captured behind the flange 24 of the first plate 10 within the arcuate locking slot 29, locking the two plates 10 and 12 together. The rotational stop(s) 30 of the first plate 10 precludes excessive rotation of the second plate fingers 40 past their engagement beneath the flange 24 of the first plate 10.

The second plate 12 of the embodiment illustrated in FIGS. 1 and 2 provides for the essentially permanent attachment of a surface mounted tool thereto. While the tool may be bolted to the second plate 12, it is considered to be an essentially permanent attachment, to the same degree as the bolting of such a tool to a workbench or other support surface would be. In the primary embodiment of FIG. 2, the second plate 12 includes a tool attachment flange or plate 42 which is spaced from the mounting surface 34. A series of tool attachment slots 44 are provided through the tool attachment plate 42, with a series of bolts 46 captured within the slots 44. The bolts 46 may be carriage bolts or other bolt configurations having square shoulders to engage the sides of the slots 44, in order to prevent rotation of the bolts 46 when torque is applied thereto during the fastening of the tool to the plate 12. Work surface mounted tools, e.g., the vise V, are conventionally provided with a series of bolt holes through a mounting base. The radially disposed slots 44 in the second plate 12 allow the bolts 46 to be positioned to align with the tool mounting holes. The tool is immovably affixed to the underlying second plate 12 by tightening a nut 48 to the shank of each of the bolts 46. Other fastener types may be used, e.g., large diameter rivets, etc. as desired.

Alternatively, the tool attachment flange 42 may be eliminated from the second plate 12 and the tool welded directly to the underlying second plate mounting surface 34, generally as indicated by the position of the tool base B disposed directly upon the underlying mounting surface 34 of the second plate 12 in FIG. 2. As another alternative, the tool (of whatever type, e.g., vise, grinder, etc.) could have the core 36 and fingers 40 of the second plate 12 cast, forged, or otherwise integrated with the tool base at the time of manufacture, if so desired.

Various working forces exerted on a tool secured to a work surface using the present modular attachment system may result in rotational forces being applied to the tool and the underlying attachment plate, which may result in loosening of the two plates. Accordingly, a lock 50 to preclude rotation of the two plates 10 and 12 relative to one another may be provided. The lock 50 may be a threaded shank or the like which engages a correspondingly threaded hole, generally as shown in FIG. 2. A lateral bar 52 or the like may be provided for manipulation of the lock 50. Once the two plates 10 and 12 are locked together, the user need only tighten the anti-rotation lock 50 through the second plate 12 to bear against the underlying first plate 10, to preclude rotation of the two plates relative to one another.

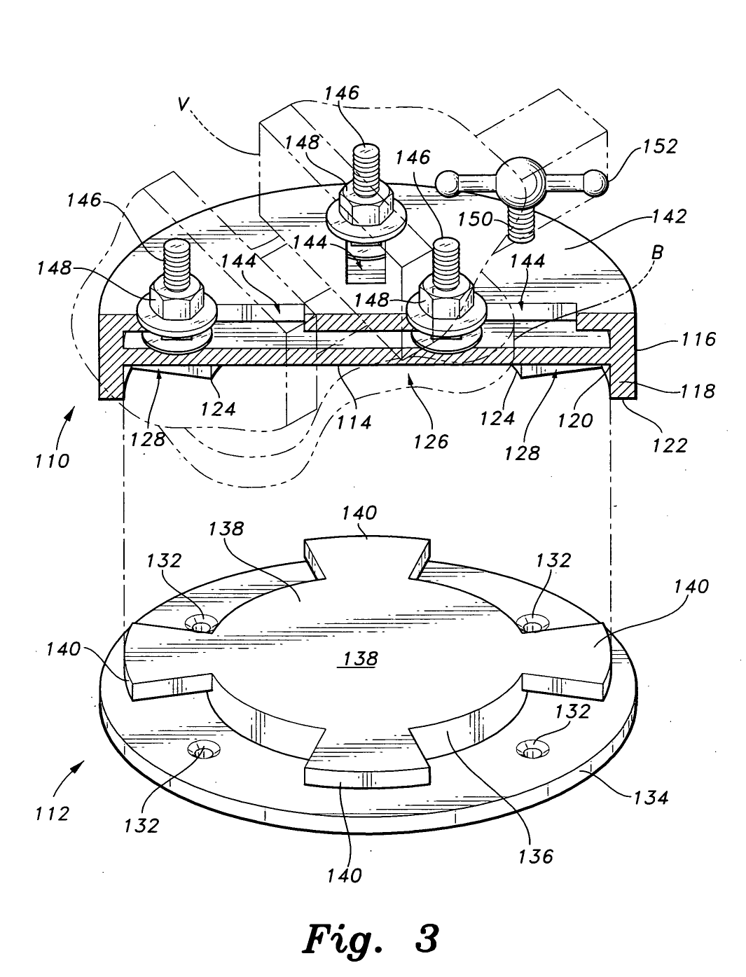

FIG. 3 provides an exploded perspective view, with one plate shown in section, of an alternative embodiment of the present modular tool attachment assembly. Essentially, the outwardly disposed fingers and the slots formed in the inwardly disposed flange of the two mating plates 110 and 112 have been reversed in FIG. 3. The first or tool mounting or female attachment plate 110 of FIG. 3 includes a base 114 having a periphery 116, with a peripheral wall 118 defining a shallow cylinder extending from its base attachment edge 120 with the base periphery 116 to an opposite flange edge 122. A flange 124 extends inwardly from the flange edge 122 of the shallow cylindrical wail 118, with the base 114, wall 118, and flange 122 defining a circular recess or first plate interior 126. The flange 124 includes a plurality of radially disposed slots 128 therein, extending inwardly from the flange edge 122 of the peripheral wall 118. The number of slots 128 may vary so long as they are identical numerically with the fingers of the second plate, as in the embodiment of FIGS. 1 and 2. Also, as in the case of the embodiment of FIGS. 1 and 2, the slots 128 of the plate embodiment 110 of FIG. 3 may be evenly or unevenly spaced, as desired. As in the case of the first embodiment of FIGS. 1 and 2, each of the flange 124 segments of the first plate 110 of FIG. 3 may include a rotational stop (not shown) extending between the flange 124 and the opposite base 114, for the same purposes described in the discussion of the stop(s) 30 of the first plate 10 of FIGS. 1 and 2.

The first plate 110 of FIG. 3 is configured for the attachment of a surface mounted tool thereto, rather than for attachment to an underlying workbench or other work surface, as in the case of the embodiment of FIGS. 1 and 2. Accordingly, the first plate 110 of FIG. 3 includes a tool attachment flange or plate 142 which is spaced from the base 114. A series of tool attachment slots 144 are provided through the tool attachment plate 142, with a series of bolts 146, essentially identical to the bolts 46 of the embodiment of FIGS. 1 and 2, captured within the slots 144. The bolts pass through conventional passages in the base B of a surface mounted tool, e.g., the vise V shown in FIGS. 1 through 3, and secure the tool to the underlying first plate 110 using a corresponding series of nuts 148, essentially in the manner used for the attachment of the tool to the second plate 12 in FIGS. 1 and 2. Alternatively, other fastener types may be used as desired, or the tool attachment flange 142 may be eliminated from the first plate 110 and the tool welded directly to the underlying first plate base 114, generally as indicated by the position of the tool base B disposed directly upon the underlying base 114 of the first plate 110 in FIG. 3. As noted in the description of the embodiment of FIGS. 1 and 2, a tool (of whatever type) could have the base 114 of the first plate 110 cast, forged, or otherwise integrated with the tool base at the time of manufacture, if so desired.

As in the case of the tool attachment embodiment of FIG. 3, a lock 150 to preclude rotation of the two plates 110 and 112 relative to one another may be provided. The lock 150 may be a threaded shank or the like which engages a correspondingly threaded hole passing through the base 114 and also through the tool attachment flange or plate 142 of the first plate (if so provided). A lateral bar 152 or the like may be provided for manipulation of the lock 150. The anti-rotation lock 150 is used in the same manner as the lock 50 of the embodiment of FIGS. 1 and 2, to preclude rotation of the two plates 110 and 112 relative to one another when the two plates are secured together.

The second male or work surface attachment or mounting plate 112 includes a mounting surface 134, with a smaller diameter central core 136 extending therefrom. The core 136 has a first plate engagement end 138 spaced from the mounting surface 134, with a series of radially disposed fingers 140 extending outwardly from the second plate engagement end 138 of the core 136, and spaced apart from the mounting surface 134. The fingers 140 of the second or work surface mounting plate 112 correspond in number and spacing to the slots 128 of the first or tool mounting plate 110, thus allowing the first or tool mounting plate 110 to be placed upon the second or work surface mounted plate 112 and rotated to engage the first plate flange 124 with the second plate fingers 140 and lock the two plates together. This arrangement may facilitate the cleanup of wood and metal chips and/or other debris from the assembly, as there is no central interior area contained within a cylindrical wall in the lower work surface mounted plate 112 embodiment.

The second plate 112 also includes at least one (preferably a series of) work surface attachment passage(s) 132 formed through the mounting surface 134. Fasteners (screws, bolts, etc.) are installed through the passages 132 to secure the second plate 112 to an underlying work surface, or alternatively to a wall structure or the like for the storage of a suitably configured tool thereon, in much the same manner described further above for the second plate 12 of FIGS. 1 and 2. Again, the passages 132 are preferably countersunk to preclude the extension of the fastener heads above the mounting surface 134, for clearance for the flange 124 of the first plate 110 when the plates are assembled to one another. Other fastener means may be used in lieu of bolts or screws through the passages 132, as described in the discussion of the embodiment of FIGS. 1 and 2.

To this point, the embodiments disclosed have each included a series of four slots in the flanged plate, and four corresponding fingers in the opposite plate. However, it is not necessary to have precisely four engaging members (slots and fingers) in each mating plate pair. FIG. 4A provides a plan view of a first male plate embodiment 210 having three fingers 240 extending from the central core 236 thereof, with the mating female second plate 212 having three corresponding slots 228 formed in its inwardly extending flange 224. In the example illustrated in FIGS. 5A and 5B, the first male plate 310 of FIG. 5A includes five fingers 340 extending from the central core 336 thereof, with the mating female second plate 312 having five corresponding slots 228 dividing the inwardly extending flange 224 into five sections. It will be understood that any practicable number of fingers and slots may be provided in the interlocking tool attachment plates of the present invention, so long as they correspond in number and spacing to one another to allow the interlocking assembly of the two plates with one another.

In particular, in its simplest form, the modular attachment may have a single finger attached to one plate and a single finger insertion slot and locking slot defined in the other plate. In some cases, this may be all that is required to connect the tool to the work surface. Alternatively, the modular attachment may have a single finger attached to one plate and a plurality of radially extending finger insertion slots and locking slots defined in the other plate. The plurality of slots permits the tool to be connected to the work surface facing in any direction defined by one of the slots without removing and re-orienting the plate attached to the work surface. Finally, the modular attachment may have a plurality of fingers attached to one plate and a plurality of finger insertion slots and locking slots defined in the other plate, as shown in the drawings. This configuration distributes any shear, bending, or torsional forces exerted by the tool from vibration or other sources over the plurality of fingers, increasing durability of the modular attachment and providing a stable base for the tool.

Each tool that the user may wish to attach to the work surface may be equipped with one of the two plates. Only a single mating plate needs to be attached to the work surface. Thus, the modular attachments of the present invention provide a quick and easy way to mount a first tool to the work surface, to disconnect the tool by simple rotation of the plates, and to then attach a second, different tool to the work surface by rotation of the plates, making the tools interchangeable. With suitable passages formed through the centers of the plates, the device could be used to secure a tool such as a router beneath a work table or the like. Thus, the present modular attachment system provides a device for any one having limited installation area for tools, or who may require that tools be removed after use, to temporarily and interchangeably install such work surface mounted tools on a workbench, tabletop, counter area, vehicle surface, or any work surface generally where such an installation may be needed.

It will be understood that, for purposes of the present invention, the term “bench top tool” means any tool normally having a base adapted for attachment to a bench top, tabletop, work table, or other work surface, including, but not limited to, a vise, a drill press, a miter or compound miter saw, a grinder or bench grinder, a mill, a press, a table saw, a router, or any other workshop tool requiring fixed mounting to a work surface for operation thereof.

It is to be understood that the present invention is not limited to the embodiments described above, but encompasses any and all embodiments within the scope of the following claims.

1. A modular attachment for surface mount tools, comprising:
a first plate having;
a base defining a periphery;
a peripheral wall extending upward around the periphery of the base, the peripheral wall having an upper edge;
a flange extending inwardly from the upper edge of the peripheral wall and defining a central circular recess, the flange having a plurality of finger insertion slots defined therein extending radially from the circular recess towards the peripheral wall, a plurality of locking slots being defined between the flange and the base;
a second plate having;
a mounting surface;
a central core extending axially from the mounting surface, the central core having a first plate engagement end spaced from the mounting surface;
a plurality of radially disposed fingers extending outwardly from the first plate engagement end of the core, the plurality of fingers corresponding in number to the plurality of finger insertion slots of the first plate flange; and
wherein the fingers pass through the finger insertion slots and are captured in the locking slots between the flange and base of the first plate upon relative rotation of the plates, thereby locking said second plate to said first plate.

2. The modular attachment according to claim 1, further including a rotational stop disposed between the flange and the base adjacent at least one of the insertion slots, defining a lateral edge of at least one of the locking slots.

3. The modular attachment according to claim 1, further including a rotation precluding lock disposed in one of said plates.

4. The modular attachment according to claim 1, wherein:
the base of said first plate has at least one work surface attachment passage defined therethrough adapted for attaching the first plate to a work surface; and
said second plate further comprises means for attaching a tool thereto.

5. The modular attachment for surface mount tools according to claim 4, wherein said means for attaching is selected from the group consisting of threaded fasteners, rivets, and weldments.

6. The modular attachment for surface mount tools according to claim 1, wherein:
the mounting surface of said second plate has at least one work surface attachment passage defined therethrough adapted for attaching the first plate to a work surface; and
said first plate further comprises means for attaching a tool thereto.

7. The modular attachment for surface mount tools according to claim 6, wherein said means for attaching is selected from the group consisting of threaded fasteners, rivets, and weldments.

8. A tool with a modular attachment for mounting the tool to a work surface, comprising:
a male attachment plate;
a female attachment plate, the male attachment plate rotatably engaging the female attachment plate in order to releasably secure the plates together; and
a bench top tool having one of the plates attached thereto, the other plate being adapted for attachment to a work surface.

9. The tool according to claim 8, wherein said male attachment plate is attached to said bench top tool.

10. The tool according to claim 8, wherein said female attachment plate is attached to said bench top tool.

11. The tool according to claim 8, further comprising at least one fastener attaching said one of the plates to said bench top tool.

12. The tool according to claim 8, wherein said bench top tool has a base member, said one of the plates being formed integrally with the base member in a single, monolithic structure.

13. The tool according to claim 8, wherein said male attachment plate comprises a disk having a core extending concentrically therefrom and at least one finger radially extending from the core, the finger being spaced apart from the disk.

14. The tool according to claim 13, wherein said female attachment plate comprises a disk having:
an upright peripheral wall defining an upper edge
a flange extending inward from the upper edge of the peripheral wall and defining a central cylindrical recess removably receiving the core of said male attachment plate, the flange having at least one finger insertion slot defined therein extending radially from the cylindrical recess toward the peripheral wall; and
a stop extending between the flange and the disk, the flange and the disk defining a locking slot extending between the finger insertion slot and the stop;
whereby the core of the male attachment plate is inserted into the cylindrical recess and the finger into the finger insertion slot, the plates being rotated to secure the finger in the locking slot in order to releasably secure the male and female attachment plates together.

15. The tool according to claim 8, further comprising a lock member selectively extending from one of the plates to bear against the other plate when the plates engage each other in order to prevent counter-rotation of the plates.

16. A modular attachment for attaching a tool to a work surface, comprising:
a first plate adapted for attachment to a bench top tool;
a second plate adapted for attachment to a work surface; and
means for releasably securing the plates together by relative rotation of the first and second plates.

17. The modular attachment according to claim 16, wherein said means for securing comprises:
a central cylindrical core extending from the first plate;
at least one finger radially extending from the central core parallel to the first plate;
an upright peripheral wall extending from the second plate and having an upper edge;
a flange extending inward from the upper edge of the peripheral wall parallel to the second plate, the flange defining a central cylindrical recess and having a plurality of finger insertion slots extending radially from the central recess toward the peripheral wall;
a stop extending between the flange and the second plate adjacent one edge of each of the finger insertion slots, the flange and the second plate defining a plurality of locking slots therebetween extending between each of the finger insertion slots and the stops;
whereby the central core and at least one finger are inserted into the central recess and one of the finger insertion slots and rotated until the finger lodges in the locking slot adjacent the finger insertion slot and bears against the stop, thereby securing the first and second plates together.

18. The modular attachment according to claim 16, wherein said means for securing comprises:
a central cylindrical core extending from the second plate;
at least one finger radially extending from the central core parallel to the second plate;
an upright peripheral wall extending from the first plate and having an upper edge;
a flange extending inward from the upper edge of the peripheral wall parallel to the first plate, the flange defining a central cylindrical recess and having a plurality of finger insertion slots extending radially from the central recess toward the peripheral wall;
a stop extending between the flange and the first plate adjacent one edge of each of the finger insertion slots, the flange and the first plate defining a plurality of locking slots therebetween extending between each of the finger insertion slots and the stops;
whereby the central core and at least one finger are inserted into the central recess and one of the finger insertion slots and rotated until the finger lodges in the locking slot adjacent the finger insertion slot and bears against the stop, thereby securing the first and second plates together.

19. The modular attachment according to claim 16, further comprising means for clamping the first and second plates together in order to prevent counter-rotation of the plates.

20. The modular attachment according to claim 16, further comprising a plurality of bench top tools, each of the tools having one of the first plates attached thereto.
